(19) United States
(12) Patent Application Publication
(10) Pub. No.: US 2025/0037528 A1
(43) Pub. Date: Jan. 30, 2025

(54) DEVICE FOR ILLUMINATING VALUE DOCUMENTS, SENSOR FOR TESTING VALUE DOCUMENTS, AND VALUE DOCUMENT-PROCESSING SYSTEM

(71) Applicant: GIESECKE+DEVRIENT CURRENCY TECHNOLOGY GMBH, München (DE)

(72) Inventors: Joseph LOHNER, Munchen (DE); Klaus THIERAUF, Munchen (DE)

(21) Appl. No.: 18/697,058

(22) PCT Filed: Sep. 29, 2022
(86) PCT No.: PCT/EP2022/025453

§ 371 Date: Mar. 29, 2024

(30) Foreign Application Priority Data
Sep. 30, 2021 (DE) 10 2021 004 924.1

(51) Int. Cl. G07D 7/12; G07D 11/12

(52) U.S. Cl. CPC G07D 7/12; G07D 11/12

(57) ABSTRACT

A device is provided for illuminating value documents to a sensor for testing value documents, and to a value document-processing system. The device has a support element and multiple radiation sources which are arranged in a row on the support element, and which are designed to emit electromagnetic radiation in order to illuminate a value document. The support element is equipped with a recess which is arranged at a distance to the radiation sources arranged in the row and which ex-tends over a first section of the row, wherein the support element has a heat-transfer capability in a support element region lying on the first section of the row, said heat-transfer capability being reduced in comparison to a support element region lying on another section of the row.

The invention relates to a device for illuminating valuable documents, in particular banknotes, a sensor for checking valuable documents, and a valuable document processing system.

What may arise in the case of the optical sensor and illumination modules used in the context of automated processing of valuable documents, in particular banknotes, is that the light sources typically arranged in a line, for example light-emitting diodes, emit light with a different spectral composition or color depending on the position and/or have different service life durations.

It is an object of the invention to specify a device for illuminating valuable documents, a sensor for checking valuable documents, and a valuable document processing system in which an occurrence of positionally dependent differences in the radiation sources, in particular in respect of the spectral composition of the emitted electromagnetic radiation and/or in respect of the service life or aging, is prevented or at least reduced in a simple and reliable manner.

This object is achieved by a device as claimed in the independent claim, by a sensor having such a device, and by a valuable document processing system having such a device and/or such a sensor.

A device for illuminating valuable documents, in particular banknotes, in accordance with a first aspect comprises a carrier element and a plurality of radiation sources arranged on the carrier element in a row and configured to emit electromagnetic radiation for illuminating a valuable document, and is characterized in that a cutout is provided in the carrier element in a manner spaced apart from the radiation sources arranged in the row and extending over a first portion of the row, whereby the carrier element has a heat transfer capability in a region of the carrier element located in the first portion of the row which is reduced in relation to that in a region of the carrier element located in another portion of the row.

A sensor for checking valuable documents, in particular banknotes, in accordance with a second aspect comprises: a device for illuminating valuable documents in accordance with the first aspect and a device for detecting the radiation emanating from a valuable document irradiated with electromagnetic radiation by the illumination device.

A valuable document processing system according to a third aspect comprises: one or more devices for processing, in particular separating, transporting, testing, sorting, dispensing and/or destroying, valuable documents, in particular banknotes, and a device for illuminating valuable documents in accordance with the first aspect and/or a sensor for checking valuable documents in accordance with the second aspect.

Aspects of the present disclosure are preferably based on the approach of providing a cutout in the carrier element, by means of which the heat transfer from and/or to a first portion of the row in which radiation sources are arranged is impeded (e.g., in the case of a cutout formed as a perforation) or reduced in comparison with the heat transfer from and/or to other portions of the row (e.g., in the case of a cutout formed as a depression). In particular, this at least partially suppresses or impedes the dissipation of heat from the row or the radiation sources over a region of the carrier element located at the first portion of the row and/or reduces said heat dissipation in relation to that in regions of the carrier element located at the other portions of the row, with the result that the heat dissipation from the row is still implemented substantially only over the regions of the carrier element located at the other portions of the row or is implemented predominantly over the regions of the carrier element located at the other portions of the row.

In the case of heat hotspots and/or heat sources which are formed for example by the radiation sources themselves and/or other components on or at the carrier element and which occur during the operation of the device, this leads to the temperature being raised in the region of the carrier element located at the first portion of the row, in comparison with the case where no such cutout is provided.

This is particularly advantageous in applications where the heat hotspots or heat sources lead to the regions of the carrier element located at the other portions of the row heating up more strongly than the region located at the first portion of the row. This is because the temperature difference between the region of the carrier element located at the first portion of the row and the regions of the carrier element located at the other portions of the row is reduced or, in the ideal case, even essentially compensated in its entirety as a result of the cutout extending at a distance from the first portion of the row. What this achieves is that the radiation sources arranged in the row are operated at similar or substantially the same temperatures, independently of their position in the first portion or any other portions of the row. Temperature-related differences in the spectral composition of the electromagnetic radiation emitted by the radiation sources and/or in the service life or aging of the radiation sources are prevented or at least reduced thereby. Further, this can also reduce the outlay and the need for a possible correction of the individual radiation sources, for example by way of increasing the respective operating voltage. Since the correction itself generates additional exhaust heat, this avoids or at least reduces an additional development of heat. Since there are technical limits to the possible extent of the correction (i.e., it is not possible to make arbitrarily large corrections), this moreover ensures that, if necessary, it is always possible to make corrections within what is technically possible.

Overall, the invention easily and reliably prevents or at least reduces an occurrence of positionally dependent differences in respect of the spectral composition of the electromagnetic radiation emitted by the radiation sources and/or in respect of the service life or aging of the radiation sources.

In the sense of the present disclosure, the term “heat transfer capability” should be understood to mean the capability of the carrier element or relevant region of the carrier element to transfer, in particular dissipate, heat, predominantly by means of thermal conduction. Thus—in contrast with the thermal conductivity characterizing a substance property—the heat transfer capability within the meaning of the present disclosure is a property of the carrier element given not only by the thermal conductivity of the material which makes up the carrier element but also by the shape and/or the geometry of the carrier element.

In the sense of the present disclosure, a row in which the radiation sources are arranged should be understood to mean any one-dimensional or two-dimensional arrangement of radiation sources, in which the radiation sources are arranged next to one another along at least one straight or curved line. In this context, neighboring radiation sources may be at a distance from one another or in contact. The row of radiation sources preferably has an elongate form. In the context of the present disclosure, the terms “row”, “line”, and “array” are used synonymously provided nothing to the contrary is stated.

In the sense of the present disclosure, a cutout spaced apart from the radiation sources arranged in the row and extending over a first portion of the row should be understood to mean any depression in the carrier element which for example runs parallel or at an angle to the row and whose extent in the direction of the row substantially corresponds to the extent of the first portion of the row.

The radiation sources are preferably light-emitting diodes (LEDs) or organic light-emitting diodes (OLEDs). The electromagnetic radiation emitted by the radiation sources, in particular by light-emitting diodes, and used for illuminating the valuable document is preferably in the visible, infrared, and/or ultraviolet spectral range.

By preference, the row in which the radiation sources are arranged runs substantially in a straight line. The radiation sources, in particular light-emitting diodes, in this case form what is known as a linear array, in particular a linear LED array or an LED line.

By preference, the cutout extends substantially parallel to the row of radiation sources, the latter preferably running in a straight line, in particular parallel to the first portion of the row of radiation sources. This easily uniformly impedes or reduces the heat transfer in the region of the carrier element located at the first portion of the row, with the result that possible positionally dependent temperature differences between the radiation sources located in the first portion can be kept small.

By preference, the first portion of the row, over which the cutout extends, is located at one end of the row. In an alternative or in addition, it is preferable for the cutout to be located at one edge of the carrier element. The heat transfer capability of the carrier element is easily reduced in a region located at the end of the row by way of the cutout extending over the first portion at the end of the row, in particular parallel therewith. For example, this is particularly advantageous in applications in which the heat can be dissipated relatively well at the relevant end of the row sans cutout in comparison with the remainder of the row, for example on account of adjacent elements (e.g., metallic plates, housing parts, etc.) with good heat transfer properties and/or on account of a lack of heat sources present. A corresponding statement applies to the aforementioned preferred variant, in which the cutout is located at an edge of the carrier element.

By preference, the first portion of the row has a greater distance from at least one heat source occurring or located on the carrier element during the operation of the device and/or heat hotspot occurring on the carrier element during the operation of the device than the other portion of the row. As a result, the cutout spaced apart from the row and extending over the first portion of the row is located level with or in the region of the colder first portion of the row, whereby the heat dissipation from the colder first portion of the row is impeded while the heat dissipation from the other portion of the row can be implemented in unimpeded fashion. As a result, the temperature differences between the portions of the radiation sources arranged in the row that are caused by the heat source(s) or hotspot(s) during the operation of the device can be reduced or even compensated for, with the result that the radiation sources are operated at similar or substantially the same temperatures.

By preference, the carrier element has a panel-shaped carrier on which the radiation sources are arranged and in which the cutout is provided. For example, the carrier element or panel-shaped carrier can be a printed circuit board (carrier element for electronic components) and/or a part or portion of a housing of an illumination and/or sensor module, in which the device is integrated.

By preference, the cutout is in the form of a depression, in particular a contiguous depression, in the carrier element. In this case, the height of the depression is less than the height or thickness of the carrier element in the region of the depression. Even if heat can be transferred via a connecting piece remaining on the carrier element in this embodiment, the heat transfer capability of the carrier element vis-à-vis that in regions without depression is easily reduced by way of the depression, without substantially modifying the statics of the carrier element at this point.

By preference, the cutout is in the form of a perforation, in particular a contiguous perforation, in the carrier element. In this case, the perforation extends over the entire height or thickness of the carrier element. As a result, the heat transfer through the carrier element is easily suppressed at this location.

Further advantages, features and application possibilities of the present invention arise from the following description in connection with the figures. In detail:

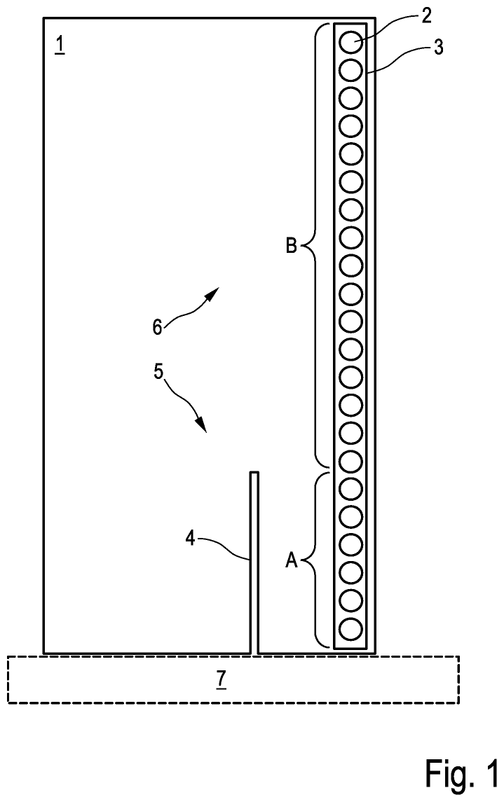

FIG. 1 shows a plan view of a first example of a device;

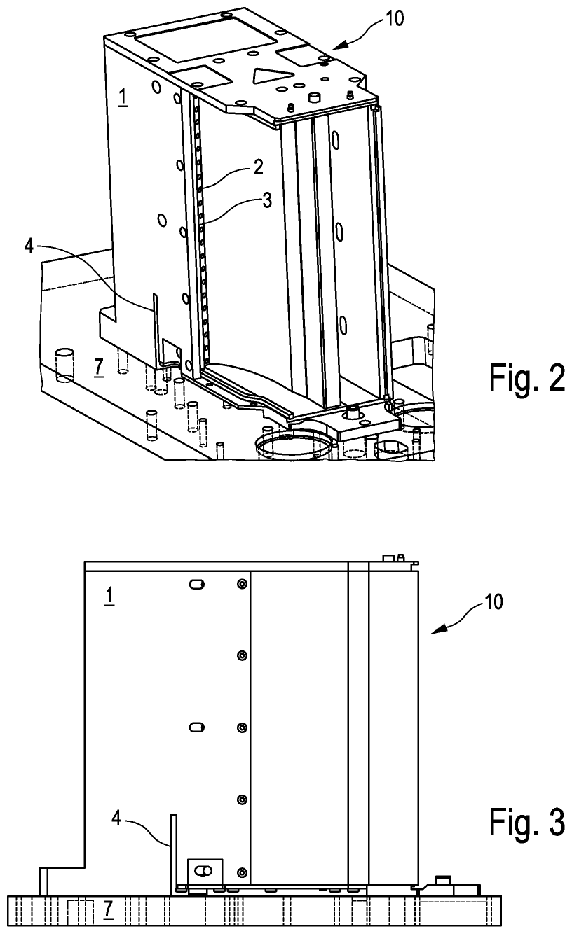

FIG. 2 shows a perspective view of a second example of a device;

FIG. 3 shows a side view of the second example of the device;

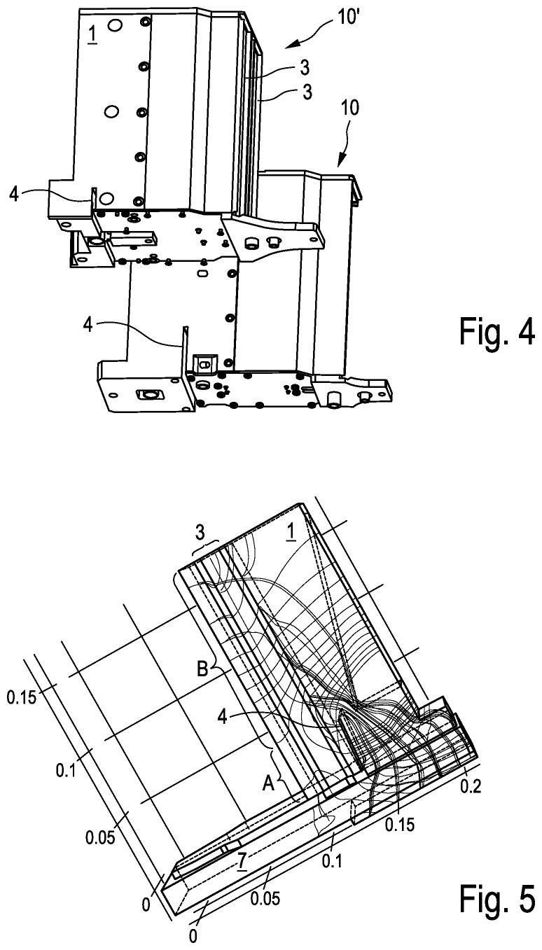

FIG. 4 shows a perspective view of the second example of the device (in the background) and of a third example of the device (in the foreground);

FIG. 5 shows a schematic illustration of an example of a temperature distribution in the second example of the device;

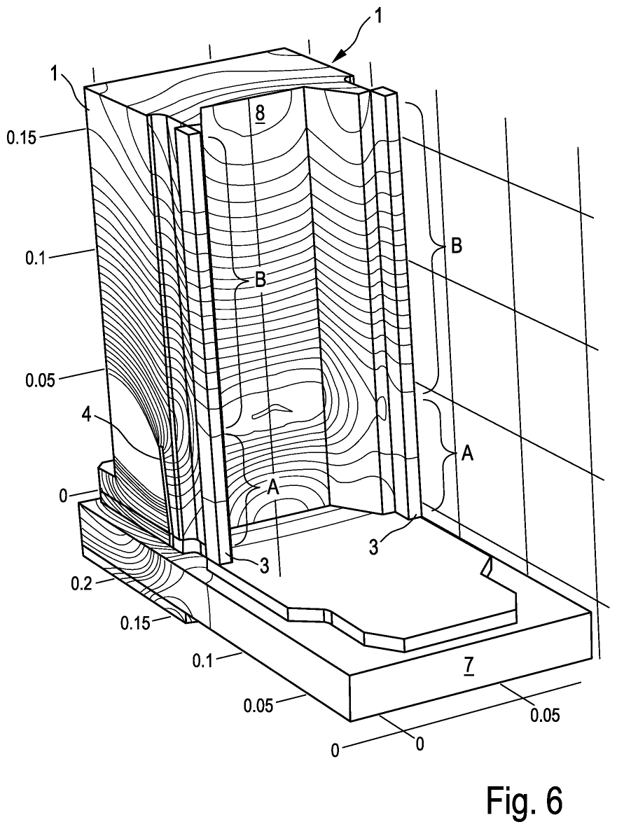

FIG. 6 shows a schematic illustration of an example of a temperature distribution in the third example of the device; and

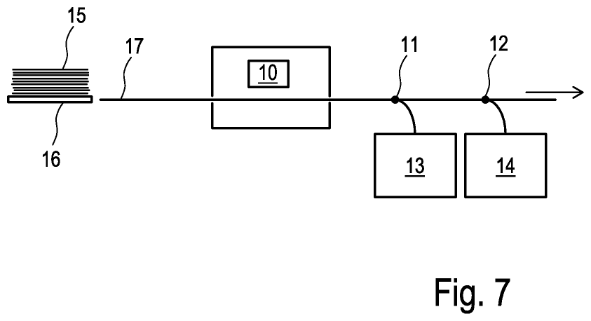

FIG. 7 shows an example of a valuable document processing system.

FIG. 1 shows a first example of a device. A multiplicity of radiation sources 2, for example light-emitting diodes, are arranged in a row 3 on a carrier element 1, which for example is in the form of a printed circuit board or which forms a part of a housing (not depicted here).

A cutout 4, formed as a recess or elongate perforation at the edge of the carrier element 1 in the present example and running substantially parallel to the row 3, is provided in the carrier element 1 at a distance from the radiation sources 2 arranged in the row 3. The length of the cutout 4 is chosen such that the latter extends over a first portion A of the row 3.

The cutout 4 results in a reduction in the heat transfer capability of the carrier element 1 in a region 5 located at the first portion A of the row 3 in relation to that in a region 6 located at the adjacent second portion B of the row 3, with the result that heat dissipation from the first portion A of the row 3 is impeded or reduced in comparison with a heat dissipation from the second portion B of the row 3.

If the radiation sources 2 situated in the second portion B of the row 3 heat up more strongly during the operation of the device than the radiation sources 2 situated in the first portion A of the row 3, for example on account of so-called heat hotspots on the carrier element 1 and/or a heat sink 7, for instance in the form of a metallic plate resting against the edge of the carrier element 1, then the cutout 4 impedes or at least reduces the heat dissipation from the colder or less warm portion A of the row 3 through the region 5 of the carrier element 1, with the result that heat can be dissipated predominantly or substantially only still via the region 6 of the carrier element 1 located at the warmer second portion B of the row 3. This can reduce or ideally even compensate temperature differences between the radiation sources 2 located in the first portion A of the row 3 and the radiation sources 2 located in the second portion B of the row 3. This reduces or eliminates temperature-related differences, in particular in respect of the color of the electromagnetic radiation emitted by the radiation sources 2 and the service life of the radiation sources 2.

FIGS. 2 and 3 show a perspective view and a side view, respectively, of a second example of a device, in which the carrier element 1 is formed by a side plate of a housing of an illumination and/or sensor module 10 for illuminating or checking valuable documents. In the present example, the radiation sources 2 arranged in a row 3 (only visible in FIG. 2) are situated in the region of a front edge of the carrier element 1. A cutout 4 which is in the form of an elongate recess running substantially parallel to the row 3 and which is spaced apart from the row 3 and offset in the direction of the back edge of the carrier element 1 is provided in the carrier element 1. In the present example, the illumination and/or sensor module 10 is mounted via a lower housing plate on a metal plate 7 of a valuable document processing system (not illustrated) which may represent a heat sink during the operation of the device, by means of which heat can be dissipated from the carrier element 1, especially from another portion of the row 3. In respect of the technical effects of the cutout 4, the explanations given above in the context of the example shown in FIG. 1 apply correspondingly.

FIG. 4 shows a perspective view of the second example of the device integrated in an illumination and/or sensor module 10 (in the background) and of a third example of a device integrated in an illumination and/or sensor module 10′ (in the foreground), in which radiation sources are arranged in two rows 3. Accordingly, in the third example, a respective cutout 4 is preferably provided both in the front carrier element 1 (front side plate of the module 10′) and in the opposite back carrier element (back side plate of the module 10′), which is not visible in the illustration. The length of the cutout(s) 4 is shorter in the third example than in the second example. Otherwise, the explanations given above in the context of FIGS. 1 to 3 apply correspondingly to the third example.

FIG. 5 shows a schematic illustration of an example of a temperature distribution in the second example of the device, with regions depicted in darker fashion symbolizing lower temperatures than regions depicted in brighter fashion. As may be gathered from the illustration, the cutout 4 provided in the carrier element 1 prevents the region of the carrier element 1 adjacent to the first portion A of the row 3 from cooling down too much in comparison with the region of the carrier element 1 located at the other portion B of the row 3 (compare the lower temperatures in the region located to the right of the cutout 4 vis-à-vis the temperatures in the region adjacent to the first portion A to the left of the cutout 4). This reduces temperature differences between the portions A and B, whereby a more uniform or, in the ideal case, even a substantially identical temperature control of the radiation sources (not depicted here) arranged in the row 3 is achieved. Otherwise, the explanations given above in the context of FIGS. 1 to 3 apply correspondingly.

FIG. 6 shows a schematic illustration of an example of a temperature distribution in the third example of the device, with regions depicted in darker fashion symbolizing lower temperatures than regions depicted in brighter fashion. As may be gathered from the illustration, the cutout 4 provided in the respective carrier element 1 prevents the region of the carrier element 1 adjacent to the respective first portion A of the row 3 from cooling down too significantly in comparison with the region of the carrier element 1 located at the other portion B of the row 3 (compare the lower temperatures in the region located to the left or top left of the cutout 4 vis-à-vis the temperatures in the region adjacent to the first portion A to the right of the cutout 4). This reduces temperature differences between the respective portions A and B, whereby a more uniform and, in the ideal case, even a substantially identical temperature control of the radiation sources (not depicted here) arranged in the respective row 3 is achieved. In this example, a corresponding statement also applies to a depression 8 situated between the rows 3 if radiation sources and/or detector elements, arranged in a row (not depicted here), for detecting the electromagnetic radiation emanating from the irradiated valuable document are provided there—in an alternative or in addition to the rows 3 with radiation sources. Otherwise, the explanations given above in the context of FIGS. 1 to 3 apply correspondingly.

FIG. 7 shows a schematic illustration of an example of a valuable document processing system. Valuable documents 15, in particular banknotes, are provided, preferably in the form of a stack, in a receptacle device 16, which is also referred to as an introduction compartment. A separation device, which is not depicted here, is used to take the valuable documents 15 individually from the stack and transfer these to a transportation device 17, by means of which said valuable documents are conveyed through the system.

In the present example, the valuable documents 15 are initially checked in respect of their optical properties by means of a sensor 10. The sensor 10 comprises a device for illuminating valuable documents in accordance with the present disclosure and a device for detecting the electromagnetic radiation emanating from the respective illuminated valuable document, for example diffusely and specularly reflected, transmitted, and/or emitted radiation. Further sensors (not depicted here) for sensing or checking further properties of the valuable documents 15 may also be provided in addition to such an optical sensor 10.

Switches 11, 12 that are controlled on the basis of the result of the check are used to transfer the individual valuable documents 15 to a first or second container 13 or 14; these are also referred to as output compartments. In this case, for example, valuable documents 15 in a good state (“fit”) are deposited in the first container 13 and valuable documents 15 in a poor state (“unfit”) are deposited in the second container 14. Depending on the application, the valuable documents 15 in the various containers 13, 14 can also be deposited according to denomination, for example. It is also possible to provide further switches and further containers (not depicted here) or further processing elements, for example a shredder for destroying valuable documents 15 with certain properties, and this is indicated by an arrow at the end of the transportation path.

1.-11. (canceled)

12. A device for illuminating valuable documents, having:
a carrier element and
a plurality of radiation sources arranged on the carrier element in a row and configured to emit electromagnetic radiation for illuminating a valuable document,
wherein a cutout is provided in the carrier element in a manner spaced apart from the radiation sources arranged in the row and extending over a first portion of the row,
wherein the carrier element has a heat transfer capability in a region of the carrier element located in the first portion of the row which is reduced in relation to that in a region of the carrier element located in another portion of the row.

13. The device according to claim 12, wherein the row in which the radiation sources are arranged runs in a substantially straight line.

14. The device according to claim 12, wherein the cutout extends substantially parallel to the row, in particular to the first portion of the row.

15. The device according to claim 12, wherein the first portion of the row, over which the cutout extends, is located at one end of the row.

16. The device according to claim 12, wherein the cutout is located at an edge of the carrier element.

17. The device according to claim 12, wherein the first portion of the row has a greater distance from a heat source and/or a heat hotspot occurring or located on the carrier element during the operation of the device than the other portion of the row.

18. The device according to claim 12, wherein the carrier element has a panel-shaped carrier on which the radiation sources are arranged and in which the cutout is provided.

19. The device according to claim 12, wherein the cutout is in the form of a depression, in particular a contiguous depression, in the carrier element.

20. The device according to claim 12, wherein the cutout is in the form of a perforation, in particular a contiguous perforation, in the carrier element.

21. A sensor for checking valuable documents, having:
a device for illuminating valuable documents according to claim 12, and
a device for detecting the radiation emanating from a valuable document irradiated with electromagnetic radiation by the illumination device.

22. A valuable document processing system having one or more devices for processing, including separating, transporting, testing, sorting, dispensing and/or destroying, valuable documents, in particular banknotes and a device for illuminating valuable documents according to claim 12.

23. A valuable document processing system having one or more devices for processing, including separating, transporting, testing, sorting, dispensing and/or destroying, valuable documents, in particular banknotes and
a sensor for checking valuable documents according to claim 21.
